(19) United States
(12) Patent Application Publication
(10) Pub. No.: US 2026/0105311 A1
(43) Pub. Date: Apr. 16, 2026

(54) SYSTEMS AND METHODS FOR BUILDING LARGE LANGUAGE MODEL (LLM) AGENTS

(71) Applicant: Salesforce, Inc., San Francisco, CA (US)

(72) Inventors: Kung-Hsiang Huang, Champaign, IL (US); Chien-Sheng Wu, Mountain View, CA (US)

(21) Appl. No.: 19/207,747

(22) Filed: May 14, 2025

Related U.S. Application Data
(60) Provisional application No. 63/707,545, filed on Oct. 15, 2024.

(51) Int. Cl. G06N 3/0895

(52) U.S. Cl. CPC G06N 3/0895

(57) ABSTRACT

Embodiments described herein provide an evaluation framework to select AI agents on realistic CRM tasks in real-world computing environments so as to construct an AI agent for CRM scenarios. The evaluation framework includes a data generation pipeline to generate CRM data of relational objects in compliance with real-world CRM schema, a query instance generation pipeline to generate input queries into an AI agent for evaluation, and an agent testing pipeline to prompt an AI agent with the input queries and input knowledge of the CRM data (i.e., relational objects) to generate a response. The AI agent is then evaluated based in part by comparing its response with the ground-truth answers. The AI agent may also be finetuned based on a loss computed from the comparison.

### CROSS REFERENCE(S)

The instant application is a nonprovisional of and claim priority under 35 U.S.C. 119 to U.S. provisional application No. 63/707,545, filed Oct. 15, 2024, which is hereby expressly incorporated by reference herein in its entirety.

### TECHNICAL FIELD

The embodiments relate generally to machine learning systems for evaluating large language models (LLMs), and more specifically to evaluating LLM agents that perform customer relationship management (CRM) tasks, so as to build and construct improved and tailored AI agents for CRM and other scenarios.

### BACKGROUND

Artificial intelligence agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

Customer Relationship Management (CRM) systems are vital for modern enterprises, providing a foundation for managing customer interactions and data. Integrating AI agents such as large language model (LLM) agents into CRM systems can automate routine processes and enhance personalized service. However, deploying and evaluating these agents is challenging due to the lack of realistic benchmarks that reflect the complexity of real-world CRM tasks.

### BRIEF DESCRIPTION OF THE DRAWINGS

FIG. 1 illustrates an example operation of an LLM based AI agent, according to embodiments of the present disclosure.

FIGS. 2A-2B illustrate a simplified diagram illustrating an AI agent evaluation framework according to some embodiments.

FIGS. 3A-3B are simplified diagrams illustrating various aspects of a data generation pipeline as part of the AI agent evaluation framework of FIG. 1, according to some embodiments.

FIG. 3C illustrates an overview of various tasks in a query instance generation pipeline as part of the AI agent evaluation framework of FIG. 1, according to some embodiments.

FIG. 4 is a simplified diagram illustrating a computing device implementing the AI agent evaluation framework described in FIGS. 2A-2B, according to some embodiments.

FIG. 5 is a simplified diagram illustrating a neural network structure, according to some embodiments.

FIG. 6 is a simplified block diagram of a networked system suitable for implementing the AI agent evaluation framework described in FIGS. 2A-2B and other embodiments described herein.

FIG. 7 is an example logic flow diagram illustrating a method of testing an AI agent based on the framework shown in FIGS. 2A-2B, according to some embodiments.

FIGS. 8A-8B represent exemplary test results using embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

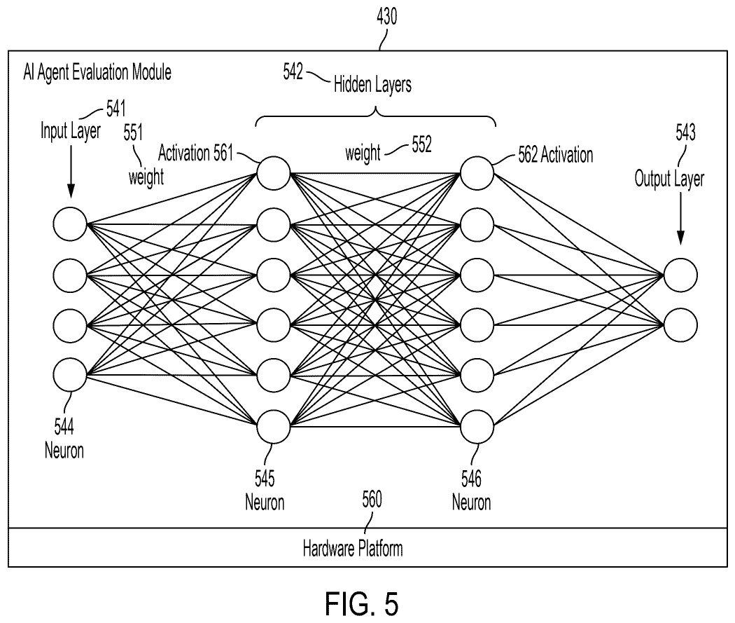

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 5.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

The integration of artificial intelligence (AI) agents based on large language models (LLMs) into Customer Relationship Management (CRM) systems promises to automate routine tasks, enhance operational efficiency, and provide personalized customer experiences. One challenge in developing these CRM systems is the lack of robust benchmarks that faithfully capture the complexity and diversity of tasks encountered in real-world CRM environments. For example, existing CRM agents generally focus on simple tasks like filtering tables and navigating menus. While these CRM agents may be tested for its basic functionalities, they are often undertrained in handling and/or generating complex system/objects (e.g., tables in database schemas) and dependencies (e.g., foreign keys) between these objects. Additionally, real-world work flows often include multiple turns and/or combinations of web page navigation, decision-making and/or other generative tasks, which remain challenging for AI agents that are pretrained on corpus of single tasks.

In view of the need to adapt and/or train AI agents in CRM environments, embodiments described herein provide an evaluation framework to evaluate and select AI agents on realistic CRM tasks in real-world computing environments, so as to construct, build, and train an improved AI agent tailored for CRM scenarios. The evaluation framework includes a data generation pipeline to generate CRM data of relational objects in compliance with real-world CRM schema, a query instance generation pipeline to generate input queries into an AI agent for evaluation, and an agent testing pipeline to prompt an AI agent with the input queries and input knowledge of the CRM data (i.e., relational objects) to generate a response. The AI agent is then evaluated based in part by comparing its response with the ground-truth answers. The AI agent may also be finetuned, trained, and reconstructed, based on a loss computed from the comparison.

Embodiments described herein provide a number of benefits. The framework allows for testing various LLMs under realistic CRM datasets for metric-based results. The realistic CRM datasets The framework also accurately reflects real-world CRM tasks by analyzing distinct tasks divided into responsibilities of key personas (e.g., the Service Manager, the Service Agent, and the Service Analyst). The combination of evaluating CRM LLM agents through real-word datasets and real-word tasks results in accurate characterization of CRM LLM agents. Such an evaluation framework facilitates the construction of (or the adoption of) of various LLM models according to customer needs. With improved LLM evaluation techniques, neural network technology of constructing (or adopting) LLMs (or LLM agents) is improved.

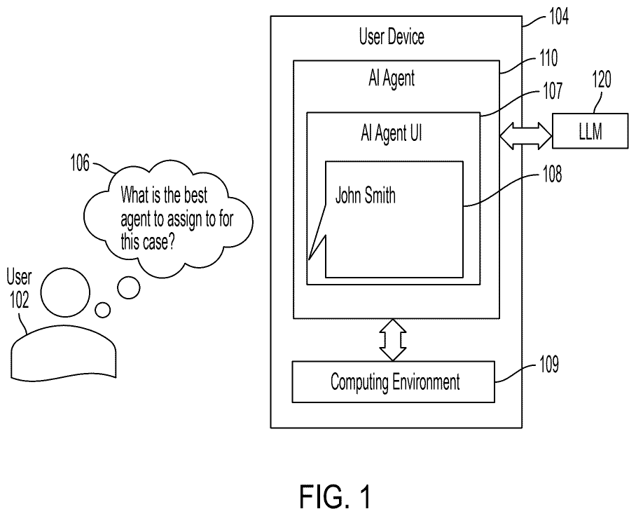

FIG. 1 shows an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to perform a CRM task request 106 such as “What is the best agent to assign to for this case?”

In one embodiment, the AI agent 110 may process the task request 106 at an LLM 120 to understand its intent, extracting key information such as the task type, task context, system description, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, e.g., suggested code program, text description, etc. The LLM 120 may in turn generate a response 108 (e.g., John Smith) based on an input combining the task request 106 and any system prompt.

The response 108 may include instructions, explanations, code scripts or direct actions to address the task request 106. Such response 108 may be displayed via the AI agent interface 107 for transparency. In addition to the response 108 that describes how to fulfill the task request, the LLM 120 may generate computer-executable commands (e.g., system-level commands, Python scripts, etc.) that can directly trigger actions and/or interactions with the computing environment 109 on the user device 104.

For example, when the user 102 requests “What is the best agent to assign to for this case?”, the LLM 120 may output a code script to execute on the computing environment 109 (such as a business application) to match cases to the most suitable human agent based on case histories and the skills and availability of these agents, and/or interface with APIs of other applications to perform function calls and query searches, and/or the like.

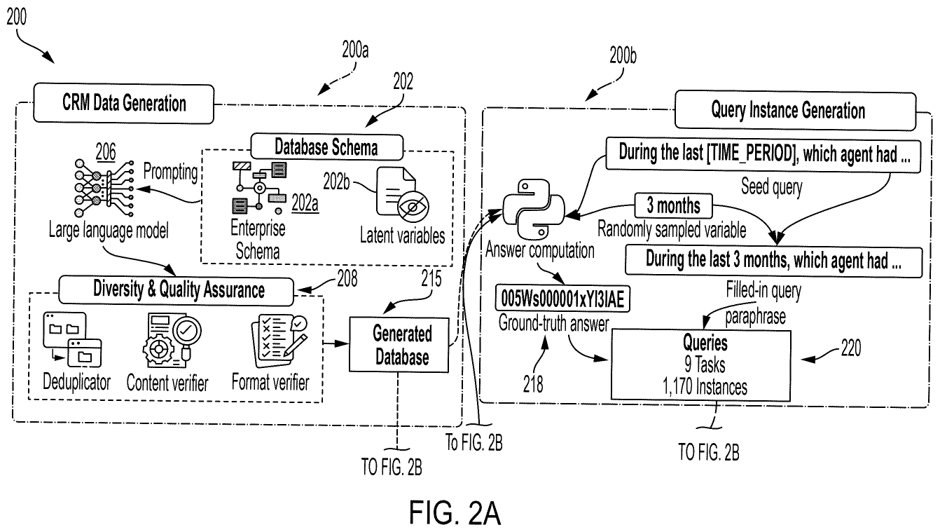

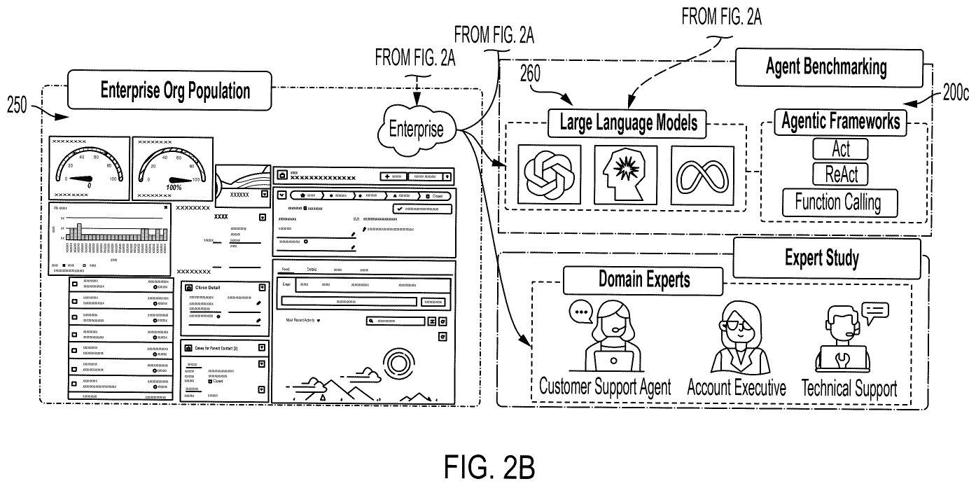

In this way, the LLM-based AI agent may facilitate end-to-end workflow to automate the task request 106. However, deploying and evaluating these agents in CRM systems is challenging due to the lack of realistic benchmarks that reflect the complexity of professional work environments. As further described in FIGS. 2-7, embodiments described herein provide an evaluation framework to evaluate AI agents on realistic CRM tasks in real-world computing environments so as to construct and deploy an AI agent for CRM scenarios.

FIGS. 2A-2B illustrate a simplified diagram illustrating an AI agent evaluation framework 200 according to some embodiments. The framework 200 includes a data generation pipeline 200a to generate relational objects (e.g., for generating input CRM data), a query instance generation pipeline 200b to generate input queries into an AI agent for evaluation, and an agent testing pipeline 200c that prompts the AI agent with the input queries and an input knowledge of the relational objects (i.e., relational objects) to generate a response. As further described herein, the data generation pipeline 200a generates realistic enterprise data and the query instance generation pipeline 200b generates realistic CRM tasks. Thereafter, the AI agent is tested on the realistic CRM tasks based on the realistic enterprise data. The AI agent (and its associated LLM) may then be updated and retrained based on a loss comparing the AI agent's performance with the ground truth.

The framework 200 begins in the data generation pipeline 200a by generating enterprise data (also referred herein as CRM data) in a computing environment and storing the generated data in a generated database 215 of the computing environment. The enterprise data will be used as realistic CRM testing data when evaluating AI agents. As described further herein, the enterprise data is organized as relational objects that reflect complex relationships between data objects. The relational objects are generated by prompting an LLM 206 to generate entries for various objects based on an input enterprise schema 202a and one or more latent (or hidden) variables 202b, which are collectively shown as database schema 202. The enterprise schema 202a may be a pre-defined database schema that defines the structure and organization of data for a business. The enterprise schema 202a may define the various objects and fields of objects (i.e., “empty” objects) to be later filled and populated with generated object entries. As described herein, each generated object entry may generate and correspond to a relational object (i.e., a “filled” object).

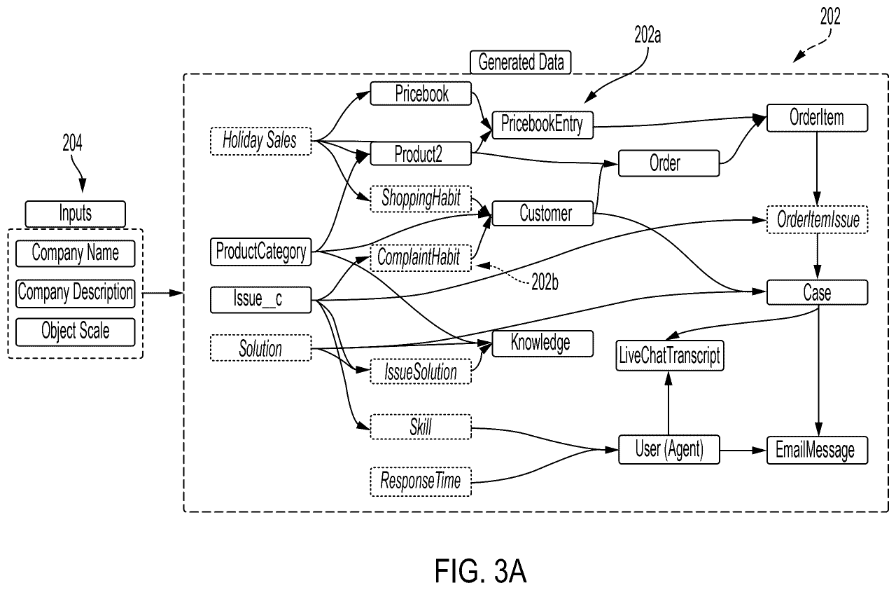

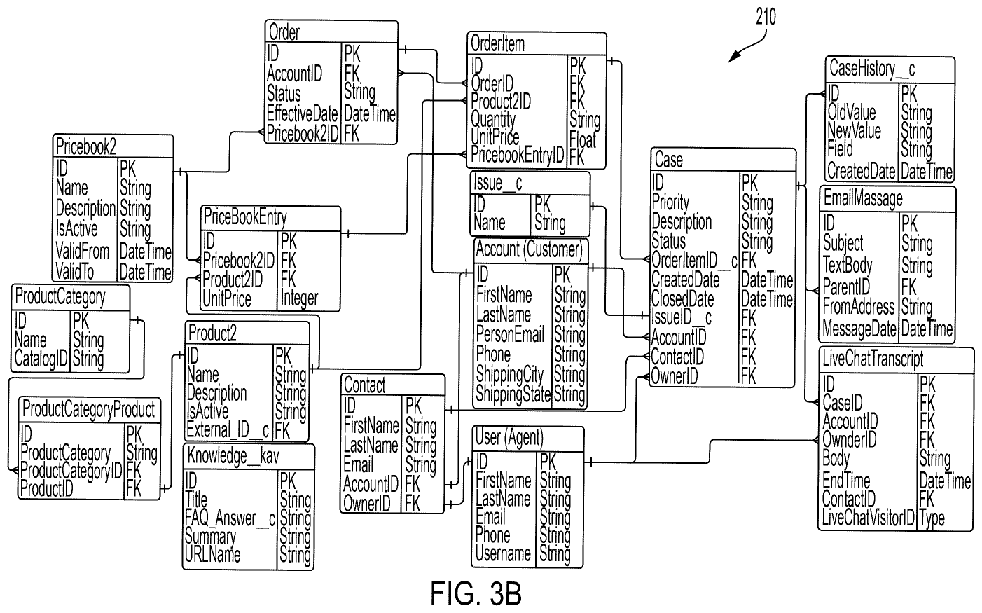

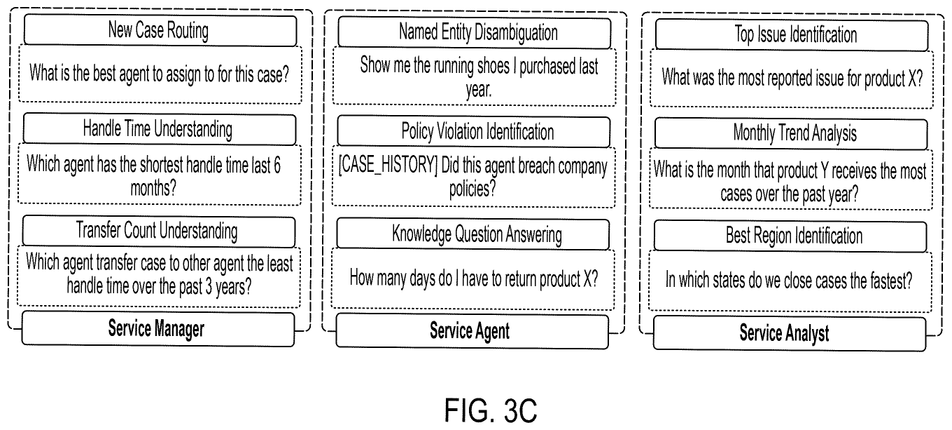

FIG. 3A illustrates a data generation overview illustrating inputs 204 into the LLM 206 to generate data outputs (i.e., objects with populated object entries) as part of the data generation pipeline 200a. In the embodiment shown, the inputs 204 may comprise a company name, a company description, an object scale (e.g., number of cases and products), along with the database schema 202 previously described. The database schema 202 provides the skeleton and framework of how objects and latent variables 202b relate to each other, and thus how the object entries are populated to generate the relational objects for use in the agent testing pipeline 200c. As shown, various latent variables 202b (e.g., Holiday Sales, ShoppingHabit, Skill, etc.) are integrated with relational objects (e.g., Customer, Order, Case, etc.) of an enterprise schema 202a to populate the object entries for each of the relational objects. In an example, the CRM testing data includes a Case object that is interdependent with other objects such as Customer and OrderItem. In an example, the latent variable OrderItemIssue shapes objects that define case issues, which may subsequently appear in live chat transcripts. In an example, the latent variable ShoppingHabit shapes objects that define what types of products a customer buys. The generation of each relational object is conditioned on a previously generated value for an object or latent variable. The latent variables 202b may be user defined and indicative of behavior patterns that lead to specific values of the one or more object entries.

The latent variables simulate various underlying factors, creating data that mirrors the subtle dependencies and patterns in authentic CRM databases. These latent variables are crucial for facilitating certain tasks and generating desired scenarios. For example, the ShoppingHabit variable allows for more realistic simulations of customer's purchasing patterns based on time periods or holiday seasons. Similarly, the Skill latent variable for the User (Agent) object enables simulations of EmailMessage and LiveChatTranscript to include situations where an agent is unable to resolve an issue and must transfer it to another agent. Without this latent variable, the Transfer Count Understanding (TCU) task would lack essential scenario information when under evaluation by the framework 200. As a result, realistic CRM testing data is generated, reflecting both actual relationships between objects as well as hidden data dynamics influencing the objects.

FIG. 3B is a diagram illustrating generated relational objects 210 and their dependencies as part of the data generation pipeline 200a, according to an embodiment. In the embodiment shown, there are sixteen relational business objects, and each of the relational objects may include one or more fields that interrelate with one or more fields of another relational object. In the embodiment shown, an average number of dependencies per object is 1.31. The shown quantity of relational objects (greater than 10) and dependencies per object (greater than 1) may provide the necessary data complexity to benchmark realistic CRM tasks.

The data generation pipeline 200a employs mini-batch prompting because of the large volume of relational objects to be generated. For example, 500 product entries paired with over 40 price book entries may result in over 20,000 price book entry items. Table 1 below illustrates an example of number of entries per object.

TABLE 1

| Object | Number of Entries |
|---|---|
| USER | 100 |
| CONTACT | 196 |
| PRODUCTCATEGORY | 12 |
| PRODUCT | 500 |
| ORDERITEM | 71,00 |
| PRICEBOOK | 44 |
| PRICEBOOKENTRY | 22,000 |
| CASE | 977 |
| ORDER | 2,071 |
| EMAILMESSAGE | 3,234 |
| LIVECHATTRANSCRIPT | 387 |
| KNOWLEDGE | 45 |

Directly prompting LLMs (e.g., LLM 206) to generate all entries of an object is thus infeasible due to the limited maximum output tokens of LLMs. To address this, the relational objects (and their associated object entries) are generated through minibatch prompting with a batch size of 10 or less. However, this approach can lead to duplicated or highly similar content across batches.

Referring back to FIG. 2A, the data generation pipeline 200a therefore includes deduplication methods as part of a diversity and quality assurance pipeline 208 of the data generation pipeline 200a. The diversity and quality assurance pipeline 208 may be implemented through one or more LLMs as judges, one or more data validation libraries or tools as part of the LLM 206, or combinations thereof. In one embodiment, for each object of the one or more objects during the minibatch prompting, a system prompt is included in the input 204 that provides all previously generated object entries in the input prompt, and the LLM 206 is instructed not to generate the previously generated object entries. In another embodiment, after the generating of the one or more objects, the diversity and quality assurance pipeline 208 employs string exact matching to remove duplicate object entries or fields of the object entries. In further embodiments, both deduplication methods are employed.

The diversity and quality assurance pipeline 208 further includes a format verifier and a content verifier. The format verifier validates whether each of the one or more object entries contains all required fields set by the pre-defined database schema (i.e., the enterprise schema 202a). Mini-batches that fail this verification are discarded and regenerated. Whereas the content verifier validates whether each of the one or more object entries is identified as corresponding to one or more reference labels. The one or more reference labels may be defined by a user as part of the input prompt or as part of the diversity and quality assurance pipeline 208. Mini-batches that fail this verification are discarded and regenerated. For example, a CRM task may need to disambiguate named entities related to customer transactions. As such, there is a need to verify that a paraphrased ambiguous product name does not deviate too much from its original name and is not too similar to other products the customer has purchased. To do so, the content verifier may provide an LLM with a list of products the customer has purchased and the paraphrased product name. If the LLM correctly identifies the product, the object entry is retained, otherwise, it is discarded.

After the relational objects (i.e., CRM testing data) are generated and filtered through the diversity and quality assurance pipeline 208, the relational objects and the latent variables 202b may be stored in the generated database 215. The CRM testing data is then uploaded and populated into a sandbox environment 250 isolated from the generated database 215. Importantly, only the CRM testing data is uploaded into the sandbox environment 250, and not the latent variables 202b. This exclusion serves two purposes: (1) it mirrors the typical scenario where companies do not have access to such hidden information, thus providing a more realistic testing environment, and (2) it adds an extra layer of challenge compared to directly testing on the generated database 215. The sandbox environment 250 may simulate a dummy organization's database where applications, code, and files can be tested or executed to see how they behave. For example, the relational objects 210 depicted in FIG. 3B is uploaded into the sandbox environment 250 without any of the latent variables 202b.

Following the creation of the CRM testing data (e.g., relational objects 210), the query instance generation pipeline 200b generates one or more query instances 220 and their ground-truth answers 218 based on the CRM testing data and the latent variables 202b. The query instances 220 corresponds to CRM tasks that the AI agent (e.g., AI agent 260) will be tested on. For knowledge-based tasks, the query instances 220 may be naively constructed by prompting an LLM each knowledge article to generate question answer pairs. For the remaining tasks, the query instances 220 are generated through a four-step process: (1) seed query construction, (2) ground-truth computation, (3) ID mapping, and (4) query paraphrasing.

As shown, seed queries may be created with placeholders for corresponding variables, such as time period or product name. This facilitates the development of functions (i.e., Answer computation) that compute the ground truth answers 218 on the generated database 215 by leveraging the latent variables 202b that are only visible there. For example, an agent's policy violation during a live chat is verifiable only within the generated database 215. Upon obtaining the answers from the generated database 215, the IDs (e.g., agent ID) in the generated database 215 is mapped to their counterparts in the sandbox environment 250, thereby establishing the ground truth answers 218 for the queries directed to the sandbox environment 250. To ensure diversity in the test queries, an LLM may be employed to paraphrase the seed queries, enhancing the robustness and variety of the benchmarking process. Additionally, some non-answerable queries may also be constructed to simulate real-world scenarios. For example, a query may request the identification of an agent who transfers the most cases during a given period, despite no agents transferring cases in that period. For these query instances 220, the expected answer from the AI agents should be “None” as outputs. In an embodiment, non-answerable queries account for 30% of the total queries per corresponding task.

In the present embodiment, the query instance generation pipeline 200b comprises 9 tasks that generates 1170 instances (e.g., 130 query instances per task). FIG. 3C illustrates an overview of various tasks generated in the query instance generation pipeline 200b, according to some embodiments. In the present embodiment, the 9 tasks are addressed by CRM personas: service manager, service agent, and service analyst.

Under the service manager persona, the tasks include: (1) New Case Routing (NCR) to assess LLM agent's ability to match cases to the most suitable agent based on case histories and the skills and availability of these agents; (2) Handle Time Understanding (HTU) to determine the human agent who handled the previous cases the fastest/slowest; and (3) Transfer Count Understanding (TCU) to find out which human agent transferred cases to others the least/most given a period of case history.

Under the service agent persona, the tasks include: (4) Name Entity Disambiguation (NED) to assess LLM agent's ability to understand product names and customer order histories; (5) Policy Violation Identification (PVI) to determine if any company policies have been breached; and (6) Knowledge Question Answering (KQA) to evaluate the agent's capacity to look for accurate and relevant information from the CRM knowledge repository.

Under the service analyst persona, the tasks include (7) Top Issue Identification (TII) to identify the most reported issue for a particular product; (8) Monthly Trend Analysis (MTA) to determine which months have the highest number of cases for a given time period; and (9) Best Region Identification (BRI) to identify the regions where cases are closed the fastest.

Referring back to FIG. 2B, upon generating the query instances 220, the evaluation framework 200 includes an agent testing pipeline 200c to prompt the AI agent 260 with the input query instances 220 and an input knowledge of the CRM data (i.e., relational objects 210). The AI agent 260 may correspond to an AI agent 110 (shown in FIG. 1) and includes a corresponding LLM (e.g., LLM 120) under an agentic framework. The agentic frameworks may include Act, ReAct, and Function Calling (FC). ReAct is a prompt-based method, with each step characterized by a thought and action process, while Act is ReAct without the thought component. The sandbox environment 250 may be created to support a variety of general-purpose APIs, such as the Apex API, REST API, and Tooling API. This allows the AI agent 260 to execute tasks for a wide range of query instances requiring searching, filtering, and selecting. Task-specific tools in the form of Python wrapper functions may also help facilitate the evaluation of function-calling agents. These functions optimize task performance by providing structured and logical operations directly mapped to typical CRM tasks. The agent testing pipeline 200c may define these wrapper functions on top of general-purpose APIs (which may support object query languages such as Salesforce Object Query Language (SOQL) and/or Salesforce Object Search Language (SOSL)) to streamline function calls and target components needed for each task. These task-specific functions are designed to maximize reusability across various tasks, minimizing the need for task-specific customizations.

The AI agent 260 generates a response based on input knowledge of the relational objects 210 and without knowledge of the latent variables 202b. The response is an action executed on the sandbox environment 250. If an action succeeds, the sandbox environment 250 will return the queried data in the sandbox environment 250; otherwise, an error message, such as incorrect function calling parameters, is returned. The AI agent 260 is evaluated based in part by comparing its response with the ground-truth answers 218. For the knowledge question answering task, the response is evaluated by calculating the F1 score. For the remaining tasks, the response is compared to the ground truth answers 218 to determine exact match (i.e., determining match between the predicted object ID and the ground truth object ID). Evaluation results may be validated through expert study. The LLM of the AI agent 260 may be then updated based on a training loss comparing the response with the corresponding ground-truth answer 218. For example, the LLM may be retrained and/or finetuned through backwards propagation, as further detailed herein.

### Computer and Network Environment

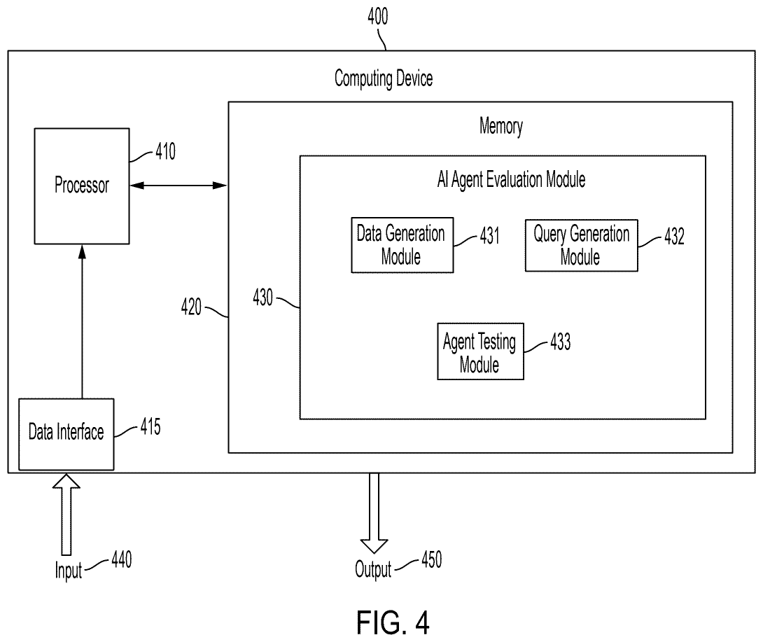

FIG. 4 is a simplified diagram illustrating a computing device implementing the AI agent evaluation framework 200 described in FIGS. 2 and 3A-3C, according to one embodiment described herein. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 5.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for AI agent evaluation module 430 that may be used to implement and/or emulate the systems and models, and/or to implement any of the methods described further herein. AI agent evaluation module 430 may receive input 440 such as input training data (e.g., predefined database schema 202a, latent variables 202b, and other inputs 204) via the data interface 415 and generate an output 450 which may be an AI agent action that retrieves an object ID from a sandbox database (e.g., sandbox environment 250).

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as predefined database schema 202a, latent variables 202b, and other inputs 204, from a user via the user interface.

In some embodiments, the AI agent evaluation module 430 is configured to implement multiple LLMs through multiple submodules. For example, the AI agent evaluation module 430 may further include data generation module 431 to implement the data generation pipeline 200a, query generation module 432 to implement the query instance generation pipeline 200b, and agent testing module 433 to implement the agent testing pipeline 200c.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified diagram illustrating the neural network structure implementing the AI agent evaluation module 430 described in FIG. 4, according to some embodiments. In some embodiments, the AI agent evaluation module 430 and/or one or more of its submodules 431-433 may be implemented at least partially via an artificial neural network structure shown in FIG. 5. The neural network comprises a computing system that is built on a collection of connected units or nodes, referred to as neurons (e.g., 544, 545, 546). Neurons are often connected by edges, and an adjustable weight (e.g., 551, 552) is often associated with the edge. The neurons are often aggregated into layers such that different layers may perform different transformations on the respective input and output transformed input data onto the next layer.

For example, the neural network architecture may comprise an input layer 541, one or more hidden layers 542 and an output layer 543. Each layer may comprise a plurality of neurons, and neurons between layers are interconnected according to a specific topology of the neural network topology. The input layer 541 receives the input data (e.g., 440 in FIG. 4), such as predefined database schema 202a, latent variables 202b, and other inputs 204. The number of nodes (neurons) in the input layer 541 may be determined by the dimensionality of the input data. Each node in the input layer represents a feature or attribute of the input.

The hidden layers 542 are intermediate layers between the input and output layers of a neural network. It is noted that two hidden layers 542 are shown in FIG. 5B for illustrative purpose only, and any number of hidden layers may be utilized in a neural network structure. Hidden layers 542 may extract and transform the input data through a series of weighted computations and activation functions.

For example, as discussed in FIG. 4, the AI agent evaluation module 430 receives an input 440 of predefined database schema 202a, latent variables 202b, and other inputs 204 and transforms the input into an output 450 of an AI agent action that retrieves an object ID from a sandbox database (e.g., sandbox environment 250). To perform the transformation, each neuron receives input signals, performs a weighted sum of the inputs according to weights assigned to each connection (e.g., 551, 552), and then applies an activation function (e.g., 561, 562, etc.) associated with the respective neuron to the result. The output of the activation function is passed to the next layer of neurons or serves as the final output of the network. The activation function may be the same or different across different layers. Example activation functions include but are not limited to Sigmoid, hyperbolic tangent, Rectified Linear Unit (ReLU), Leaky ReLU, Softmax, and/or the like. In this way, after a number of hidden layers, input data received at the input layer 541 is transformed into rather different values indicative data characteristics corresponding to a task that the neural network structure has been designed to perform.

The output layer 543 is the final layer of the neural network structure. It produces the network's output or prediction based on the computations performed in the preceding layers (e.g., 541, 542). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the AI agent evaluation module 430 and/or one or more of its submodules 431-433 may comprise the transformative neural network structure of layers of neurons, and weights and activation functions describing the non-linear transformation at each neuron. Such a neural network structure is often implemented on one or more hardware processors 560, such as a graphics processing unit (GPU). An example neural network may be a recurrent neural network, a convolutional neural network, and/or the like.

In one embodiment, the AI agent evaluation module 430 and its submodules 431-433 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may process the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 120) may receive a natural language input (such as a question) and generate a natural language output (such as an answer to the question).

In one embodiment, the AI agent evaluation module 430 and its submodules 431-433 may be implemented by hardware, software and/or a combination thereof. For example, the AI agent evaluation module 430 and its submodules 431-433 may comprise a specific neural network structure implemented and run on various hardware platforms 560, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 560 used to implement the neural network structure is specifically configured based on factors such as the complexity of the neural network, the scale of the tasks (e.g., training time, input data scale, size of training dataset, etc.), and the desired performance.

For example, to deploy the AI agent evaluation module 430 and its submodules 431-433 and/or any other neural network models such as LLMs described in FIGS. 2A-2B onto hardware platform 560, the neural network based modules 430 and its submodules 431-433 may be optimized for deployment by converting it to a suitable format, such as ONNX or TensorRT, to improve performance and compatibility. Next, depending on the size and workload requirements for modules 430 and its submodules 431-433, hardware types may be chosen for deployment, e.g., processing capacity, GPU memory size, and/or the like. Frameworks and drivers for the chosen hardware 560 frameworks and drivers may thus be installed, such as PyTorch, TensorFlow, or CUDA, to support the hardware platform 560. Then, weights and parameters of the AI agent evaluation module 430 and its submodules 431-433 may be loaded to the hardware 560. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the AI agent evaluation module 430 and its submodules 431-433 may be deployed as a service, then they may be integrated with an API endpoint, using tools like Flask, FastAPI, or a cloud platform serverless services, and is accessible by a remote user via a network.

In another embodiment, some or all of layers 541, 542, 543 and/or neurons 542, 545, 546, and operations there between such as activations 561, 562, and/or the like, of the AI agent evaluation module 430 and its submodules 431-433 may be realized via one or more ASICs. For example, each neuron 542, 545 and 546 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the AI agent evaluation module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based AI agent evaluation module 430 and one or more of its submodules 431-433 may be trained by iteratively updating the underlying parameters (e.g., weights 551, 552, etc., bias parameters and/or coefficients in the activation functions 561, 562 associated with neurons) of the neural network based on a loss herein described. For example, during forward propagation, the training data such as predefined database schema 202a, latent variables 202b, and other inputs 204 are fed into the neural network. The data flows through the network's layers 541, 542, with each layer performing computations based on its weights, biases, and activation functions until the output layer 543 produces the network's output 450. In some embodiments, output layer 543 produces an intermediate output on which the network's output 450 is based. The network's output 450 may be an output response of a different neural network model than the one receiving the input 440. In the present embodiment, a first neural network model receives the input 440 to generate input data (e.g., relational objects) for a second neural network model of an AI agent.

The output generated by the output layer 543 of the second neural network model of the AI agent is compared to the expected output (e.g., a “ground-truth” such as the corresponding to ground-truth answers 218) from the training data (e.g., input relational objects), to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 543 to the input layer 541 of the second neural network model. These gradients quantify the sensitivity of the network's output to changes in the parameters. The chain rule of calculus is applied to efficiently calculate these gradients by propagating the gradients backward from the output layer 543 to the input layer 541.

In one embodiment, the neural network based AI agent evaluation module 430 and one or more of its submodules 431-433 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

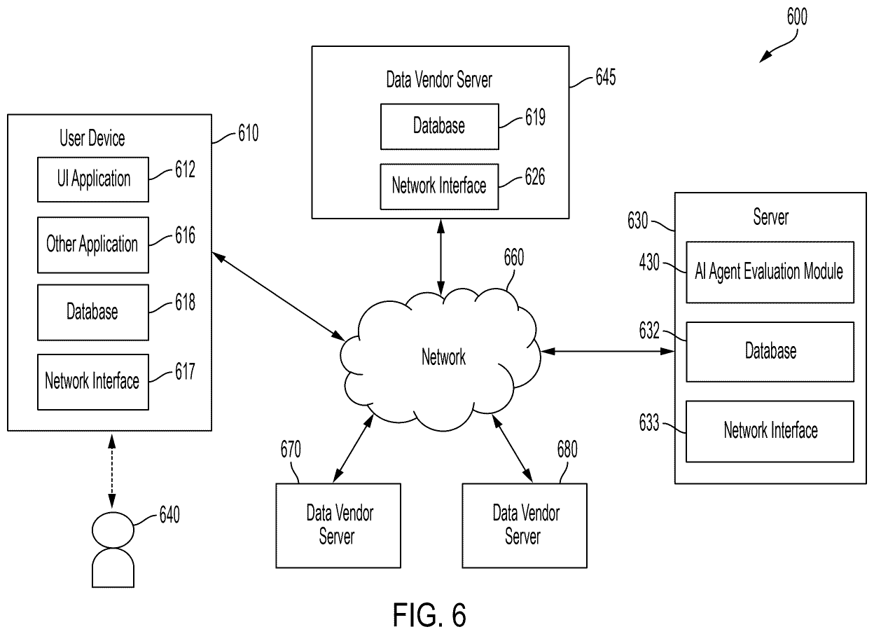

In some embodiments, AI agent evaluation module 430 and its submodules 431-433 may be housed at a centralized server (e.g., computing device 400) or one or more distributed servers. For example, one or more of AI agent evaluation module 430 and its submodules 431-433 may be housed at external server(s). The different modules may be communicatively coupled by building one or more connections through application programming interfaces (APIs) for each respective module. Additional network environment for the distributed servers hosting different modules and/or submodules may be discussed in FIG. 6.

During a backward pass, parameters of the neural network are updated backwardly from the last layer to the input layer (backpropagating) based on the computed negative gradient using an optimization algorithm to minimize the loss. The backpropagation from the last layer 543 to the input layer 541 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as determining who is the best agent to assign a case to.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in constructing (or adopting) LLMs or LLM agents. For example, the trained neural network improves the accuracy of an AI agent 260 when performing CRM tasks.

FIG. 6 is a simplified block diagram of a networked system 600 suitable for implementing the AI agent evaluation framework 200 described in FIGS. 2 and 2A-3C and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating a retrieved answer or object ID from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the AI agent evaluation module 430 (e.g., an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which AI agent evaluation module 430 may generate a response via the process described in FIGS. 2 and 3A-3C. The AI agent evaluation module 430 may thus cause a display of output 450 at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view database objects (e.g., of the sandbox environment 250).

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including various input data such as predefined database schema 202a, latent variables 202b, generated query instances 220 to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the AI agent evaluation module 430 and its submodules described in FIG. 4. In some implementations, AI agent evaluation module 430 may receive data from database 619 at the data vendor server 645 via the network 660 to generate enterprise data (e.g., relational objects 210). The generated enterprise data may also be sent to the user device 610 for review by the user 640 via the network 660.

In one embodiment, an additional AI agent implementing the AI agent evaluation module 430 and its submodules described in FIG. 4 may be built based on an LLM as described in FIG. 5. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the AI agent evaluation module 430 and its submodules described in FIG. 4 may be implemented as a cloud-based AI agent which may be accessed by user device 610 via a chatbot application, a web application, customer support or SaaS applications. In another implementation, a client-side AI agent component may be delivered from the server 630 to user device 610 for local installation such that the client-side AI agent may be installed and runs directly on the user's device. Such local AI agent on the user device 610 may be available offline to adapt to privacy-sensitive applications. In another implementation, the AI agent implementing the AI agent evaluation module 430 and its submodules described in FIG. 4 may adopt a hybrid cloud and client-based structure to balance computing speed, cost and privacy. For example, a local AI agent may handle basic AI queries locally, but complex queries may be sent to server 630 to process.

The database 632 may be stored in a transitory and/or non-transitory memory of the server 630. In one implementation, the database 632 may store data obtained from the data vendor server 645. In one implementation, the database 632 may store parameters of the AI agent evaluation module 430. In one implementation, the database 632 may store previously generated responses (e.g., by AI agent 260), and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Work Flow

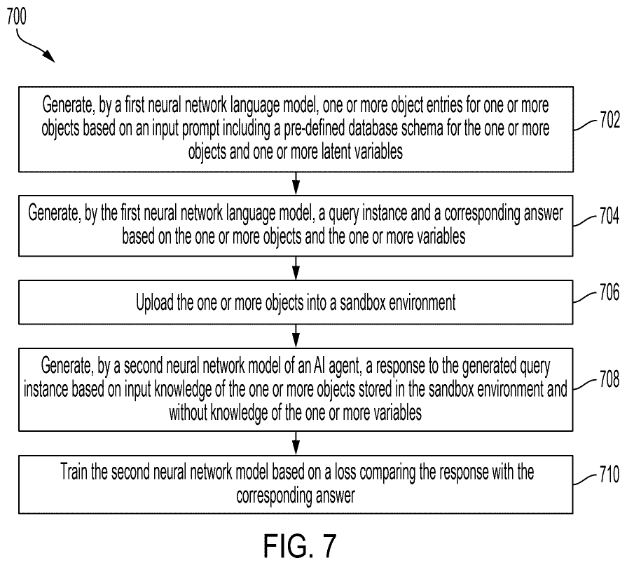

FIG. 7 is an example logic flow diagram illustrating a method of testing an artificial intelligence (AI) agent for managing data operated on a computing environment based on the framework shown in FIGS. 2 and 3A-3C, according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the AI agent evaluation module 430 (e.g., FIGS. 4 and 6). The operations may include generating and storing relational objects as input knowledge for an AI agent, generating input queries for the AI agent, and prompting the AI agent with the input knowledge and queries to evaluate AI agent performance.

In some embodiments, method 700 is performed by a system such as computing device 400, user device 610, server 630, or another device or combination of devices. Inputs (e.g., predefined database schema 202a, latent variables 202b, and other inputs 204) may be received via a data interface such as data interface 415, network interface 617, network interface 633, or via a data interface that is integrated with a device. For example, UI Application 612 may receive user inputs via a text input interface (e.g., keyboard), audio input (e.g., microphone), video interface (e.g., camera), or other interface for receiving user inputs (e.g., a mouse or touch display).

As illustrated, the method 700 includes a number of enumerated steps, but aspects of the method 700 may include additional steps before, after, and in between the enumerated steps. In some aspects, one or more of the enumerated steps may be omitted or performed in a different order.

At step 702, the method generates, by a first neural network language model (e.g., LLM 206), one or more object entries for one or more objects (e.g., relational objects 210). The one or more object entries are generated based on an input prompt including a pre-defined database schema (e.g., enterprise schema 202a) for the one or more objects and one or more latent variables (e.g., latent variables 202b). The latent variables 202b are indicative of behavior patterns that lead to specific values of the one or more object entries. Step 702 may include mini-batch prompting to generate the object entries. Step 702 may further include running the generated entries through a diversity and quality assurance pipeline 208 as herein described. The generated entries, along with the latent variables, may be stored in a generated database 215 as part of the computing environment. Step 702 may be implemented through the data generation pipeline 200a described herein.

At step 704, the method generates, by the first neural network language model (e.g., LLM 206), a query instance (e.g., query instance 220) and a corresponding answer (e.g., ground-truth answer 218) based on the one or more objects and the one or more variables e.g., latent variables 202b). Step 704 may be implemented through the query instance generation pipeline 200b described herein.

At step 706, the method uploads the one or more objects (e.g., relational objects 210) into a sandbox environment (e.g., sandbox environment 250). The one or more objects may be uploaded from the generated database 215. Note that the sandbox environment is distinct and isolated from the generated database 215 and its associated computing environment. Step 706 may be implemented through the data generation pipeline 200a described herein.

At step 708, the method generates, by a second neural network model of an AI agent (e.g., AI agent 260), a response to the generated query instance based on input knowledge of the one or more objects (e.g., relational objects 210) stored in the sandbox environment (e.g., sandbox environment 250) and without knowledge of the one or more variables (e.g., latent variables 202b). Step 708 may be implemented through the agent testing pipeline 200c described herein.

At step 710, the method trains the second neural network model based on a loss comparing the response with the corresponding answer (e.g., ground-truth answer 218). Step 708 may be implemented through the agent testing pipeline 200c described herein.

After the training, an AI agent (e.g., 110 in FIG. 1) may be built at the computing environment based on the trained second neural network model. For example, the AI agent, as described in FIG. 1, may be deployed via a cloud architecture, or locally at the user device 104 to automate workflows for a user requested task, e.g., drafting and sending emails, interacting with a customer as a virtual customer service chatbot, and/or the like.

Thus, the neural network based artificial agent (e.g., AI agent 260) may be updated and finetuned for improved performance when performing various system tasks as described herein. As such, neural network technology in automated AI agents for handling complex tasks and workflows is improved.

In some embodiments, method 700 is applicable in a variety of applications, including but not limited to CRM tasks and CRM environments described herein. For example, the task request received by a neural network model (e.g., AI agent 260) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 700, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 700 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Results

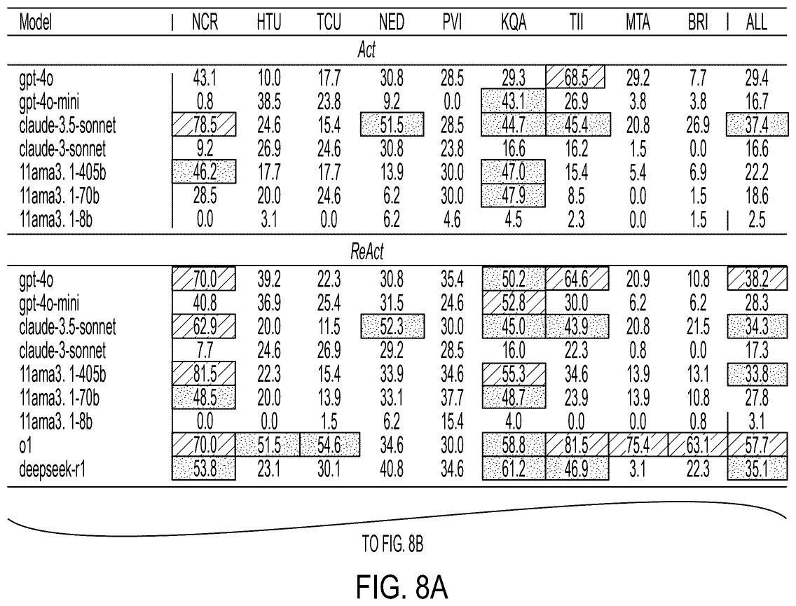

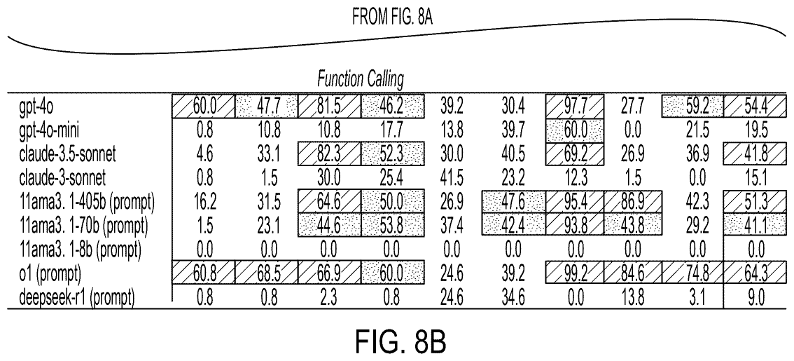

FIGS. 8A-8B represent exemplary test results using embodiments described herein. FIGS. 8A-8B illustrate overall performance, expressed as a percentage (%), of various LLMs under different agentic frameworks operating on query instances, such as query instances 220. As disclosed, query instances 220 is generated along with ground-truth answers 218 as part of the framework 200 described herein. The evaluation metric is F1 score for the knowledge question answering (KQA) task and exact match for all other tasks. All fields represent the average performance across all tasks.

Results demonstrate that the query instances 220 exhibits significant task diversity and operational complexity, which advantageously permits a more granular and differentiated evaluation of agent performance under varied real-world conditions (e.g., via realistic CRM datasets). This structured complexity facilitates improved resolution in performance measurement, enabling finer comparative analysis between models of differing capabilities and architectures.

A first observation derived from the data reveals that real-world CRM tasks, as encapsulated within the query instances 220, remain highly challenging for state-of-the-art LLM agents. For instance, within the ReAct agentic framework, the highest-performing model (referred to herein as model “01”) attains an aggregate performance score of only 57.7%. Upon equipping the same model with human-authored functional augmentations (i.e., function-calling capabilities), the score increases to a maximum of 64.3%. Such results underscore the inherent difficulty for AI agents to perform realistic CRM tasks and affirm the framework's utility in identifying the performance ceiling of advanced agentic systems.

A second notable finding concerns the heterogeneous effects of function-calling frameworks on models of varying strength. Specifically, it has been observed that higher-performing LLMs, such as GPT-40 and Claude-3.5-Sonnet, exhibit superior performance in function-calling (FC) environments, whereas lower-performing models demonstrate performance degradation when similarly augmented. This discrepancy suggests that the integration of human-defined functions does not uniformly yield beneficial outcomes and may, in certain cases, introduce operational inefficiencies, particularly where the model lacks sufficient interpretive or integrative reasoning capacity.

Of particular note is the behavior of the DeepSeek-R1 model, which, despite possessing strong intrinsic reasoning abilities, exhibits underperformance in tool-utilizing tasks. This underperformance is attributed to two key limitations: (1) inadequate compliance with user-specified instructions, and (2) insufficient responsiveness to corrective feedback or external guidance. These deficiencies further illustrate the diagnostic value of the framework 200, as it enables identification of nuanced agent limitations not readily apparent in simpler evaluation environments. Empirical evidence also supports the assertion that sufficiently capable reasoning models—such as o1—may achieve competitive or superior results in ReAct-only settings, thereby diminishing the marginal utility of function-calling enhancements. Nonetheless, the selective integration of human-crafted functions remains beneficial for maximizing performance in certain high-capability models.

Across the three agentic settings, the LLAMA models score similar, and sometimes higher, than the GPT and Claude models. This indicate a closing gap between the open and closed-source models. Results also indicate the LLAMA models tend to show higher scope for error recovery based on execution feedback than the closed-source models. The AI agent evaluation framework design, encompassing high variability and real-world task fidelity, thereby provides a robust and scalable platform for ongoing LLM performance evaluation and comparative analysis.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of testing an artificial intelligence (AI) agent for managing data operated on a computing environment, the method comprising:
generating, by a first neural network language model, one or more object entries for one or more objects of enterprise data based on an input prompt including a pre-defined database schema for the one or more objects and one or more variables indicative of behavior patterns that lead to specific values of the one or more object entries;
generating, by the first neural network language model, a query instance and a corresponding answer based on the one or more objects and the one or more variables;
uploading the one or more objects into a sandbox environment isolated from the computing environment;
generating, by a second neural network model of the AI agent, a response to the generated query instance based on input knowledge of the one or more objects stored in the sandbox environment and without knowledge of the one or more variables; and
training the second neural network model based on a loss comparing the response with the corresponding answer; and
building the AI agent based at the computing environment based on the trained second neural network model.

2. The method of claim 1, wherein the one or more object entries are generated through minibatch prompting with a batch size of 10 or less.

3. The method of claim 2, wherein the generating of the one or more object entries further comprises:
for each object of the one or more objects, providing all previously generated object entries in the input prompt during the minibatch prompting; and
instructing the first neural network language model not to generate the previously generated object entries.

4. The method of claim 2, further comprising: after the generating of the one or more objects, using string exact matching to remove duplicate object entries or fields of the object entries.

5. The method of claim 1, wherein the generating of the one or more object entries further includes:
validating whether each of the one or more object entries contains all required fields set by the pre-defined database schema;
discarding an entry of the one or more object entries based on the validating; and
regenerating a new entry for the discarded entry.

6. The method of claim 1, wherein the generating of the one or more object entries further includes:
validating whether each of the one or more object entries is identified as corresponding to one or more reference labels;
discarding an entry of the one or more object entries based on the validating; and
regenerating a new entry for the discarded entry.

7. The method of claim 6, wherein the one or more reference labels are defined by a user as part of the input prompt.

8. The method of claim 1, wherein the input prompt includes the pre-defined database schema, the one or more variables, a company name, a company description, and a scale of the enterprise data.

9. A system for testing an artificial intelligence (AI) agent for managing data operated on a computing environment, the system comprising:
a memory that stores one or more neural network models and a plurality of processor-executable instructions;
a communication interface that receives an input prompt including a pre-defined database schema for one or more objects of enterprise data and one or more variables indicative of behavior patterns that shape values of one or more object entries for the one or more objects; and
one or more hardware processors that read and execute the plurality of processor-executable instructions from the memory, wherein the plurality of processor-executable instructions are configurable to cause the system to perform operations comprising:
generating, by a first neural network language model, the one or more object entries for the one or more objects based on the input prompt having the pre-defined database schema and the one or more variables;
generating, by the first neural network language model, a query instance and a corresponding answer based on the one or more objects and the one or more variables;
uploading the one or more objects into a sandbox environment isolated from the computing environment;
generating, by a second neural network model of the AI agent, a response to the generated query instance based on input knowledge of the one or more objects stored in the sandbox environment and without knowledge of the one or more variables;
training the second neural network model based on a loss comparing the response with the corresponding answer; and
building the AI agent based at the computing environment based on the trained second neural network model.

10. The system of claim 9, wherein the one or more object entries are generated through minibatch prompting with a batch size of 10 or less.

11. The system of claim 10, wherein the generating of the one or more object entries further comprises:
for each object of the one or more objects, providing all previously generated object entries in the input prompt during the minibatch prompting; and
instructing the first neural network language model not to generate the previously generated object entries.

12. The system of claim 10, further comprising: after the generating of the one or more objects, using string exact matching to remove duplicate object entries or fields of the object entries.

13. The system of claim 9, wherein the generating of the one or more object entries further includes:
validating whether each of the one or more object entries contains all required fields set by the pre-defined database schema;
discarding an entry of the one or more object entries based on the validating; and
regenerating a new entry for the discarded entry.

14. The system of claim 9, wherein the generating of the one or more object entries further includes:
validating whether each of the one or more object entries is identified as corresponding to one or more reference labels;
discarding an entry of the one or more object entries based on the validating; and
regenerating a new entry for the discarded entry.

15. The system of claim 14, wherein the one or more reference labels are defined by a user as part of the input prompt.

16. The system of claim 9, wherein the input prompt includes the pre-defined database schema, the one or more variables, a company name, a company description, and a scale of the enterprise data.

17. A non-transitory machine-readable medium comprising a plurality of instructions, executable by one or more processors, wherein the plurality of instructions are configurable to cause the one or more processors to perform operations comprising:
generating, by a first neural network language model in a computing environment, one or more object entries for one or more objects of enterprise data based on an input prompt including a pre-defined database schema for the one or more objects and one or more variables indicative of behavior patterns that lead to specific values of the one or more object entries;
generating, by the first neural network language model, a query instance and a corresponding answer based on the one or more objects and the one or more variables;
uploading the one or more objects into a sandbox environment isolated from the computing environment;
generating, by a second neural network model of an artificial intelligence (AI) agent, a response to the generated query instance based on input knowledge of the one or more objects stored in the sandbox environment and without knowledge of the one or more variables;
training the second neural network model based on a loss comparing the response with the corresponding answer; and
building the AI agent based at the computing environment based on the trained second neural network model.

18. The medium of claim 17, wherein the one or more object entries are generated through minibatch prompting with a batch size of 10 or less.

19. The medium of claim 18, wherein the generating of the one or more object entries further comprises:
for each object of the one or more objects, providing all previously generated object entries in the input prompt during the minibatch prompting; and
instructing the first neural network language model not to generate the previously generated object entries.

20. The medium of claim 18, further comprising: after the generating of the one or more objects, using string exact matching to remove duplicate object entries or fields of the object entries.
